(19) United States
(12) Patent Application Publication
(10) Pub. No.: US 2014/0104093 A1
(43) Pub. Date: Apr. 17, 2014

(54) ELECTROMAGNETIC ANECHOIC CHAMBER

(71) Applicant: HON HAI PRECISION INDUSTRY CO., LTD., New Taipei (TW)

(72) Inventor: Ten-Chen Ho, New Taipei (TW)

(73) Assignee: HON HAI PRECISION INDUSTRY CO., LTD., New Taipei (TW)

(21) Appl. No.: 13/669,462

(22) Filed: Nov. 6, 2012

(30) Foreign Application Priority Data
Oct. 11, 2012 (CN) 2012103829101

(51) Int. Cl. H01Q 17/00

(52) U.S. Cl. 342/4

(57) ABSTRACT

An electromagnetic anechoic chamber includes an anechoic chamber having a sidewall and a top wall, and a number of hexagonal ferrite plates mounted on inner surfaces of the sidewall or the top wall. The ferrite plates are tightly arranged in a honeycomb layout. An edge length of each ferrite plate is less than a quarter of wavelength of electromagnetic wave which is required to be absorbed by the ferrite plates.

### BACKGROUND

1. Technical Field

The present disclosure relates to quality testing of information technology equipment (ITE), and particularly to an electromagnetic anechoic chamber for testing the electromagnetic interference of the ITE.

2. Description of Related Art

Electromagnetic anechoic chambers are often used in quality testing of information technology equipment (ITEs), such as personal computers, liquid crystal displays, and mobile phones. The electromagnetic anechoic chamber usually includes an anechoic chamber and a plurality of rectangular ferrite plates mounted on an inner surface of the anechoic chamber. Every two adjacent rows of ferrite plates cooperatively bound a long slot. A length of the slot is greater than the wavelength of the electromagnetic wave generated by the ITEs. Thus, some of the electromagnetic waves enter the slots and is reflected by the inner wall of the anechoic chamber via the slots, which affects the testing result.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a partially cutaway, isometric view of an exemplary embodiment of an electromagnetic anechoic chamber.

FIG. 2 is an enlarged view of the circled portion II of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

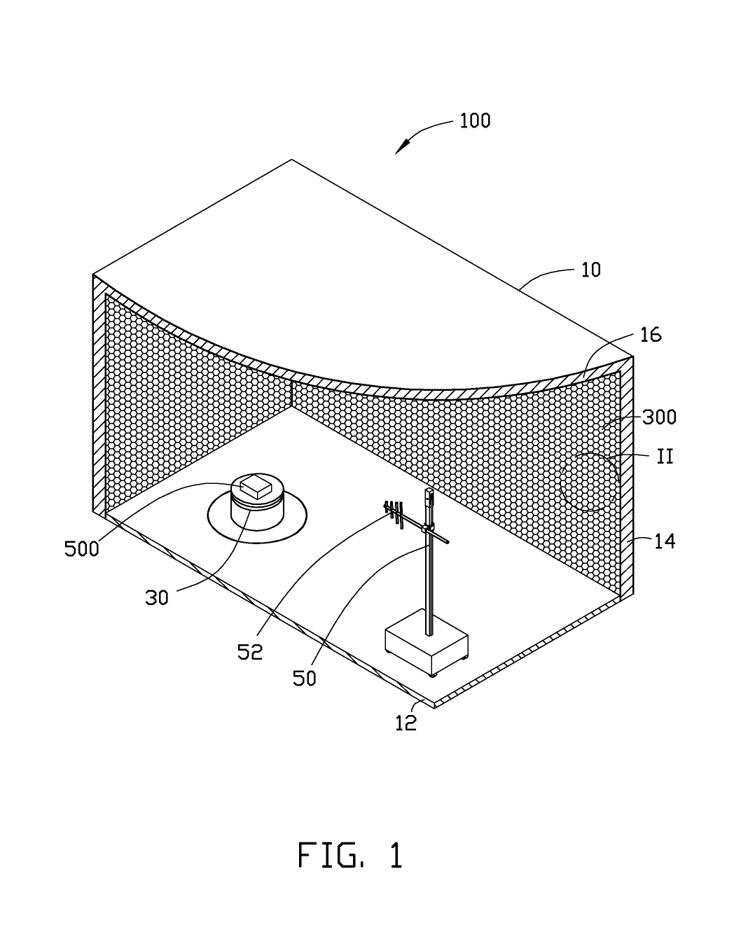

FIG. 1 shows an exemplary embodiment of an electromagnetic anechoic chamber 100. The electromagnetic anechoic chamber 100 can be used to measure intensity of electromagnetic wave generated by items of information technology equipment (ITEs) 500, such as personal computers, liquid crystal displays, and mobile telephones. The electromagnetic anechoic chamber 100 includes an anechoic chamber 10, an adjusting apparatus 30, an antenna holding device 50, and an antenna 52 mounted to the antenna holding device 50.

The anechoic chamber 10 includes a bottom wall 12, a top wall 16 parallel to the bottom wall 12, a sidewall 14 perpendicularly connected between corresponding sides of the bottom wall 12 and top wall 16, and a plurality of ferrite plates 300 tightly arranged on inner surfaces of the sidewall 14 or the top wall 16. The adjusting apparatus 30 is supported on a first end of the bottom wall 12, and the antenna holding device 50 is supported on a second end of the bottom wall 12 opposite to the adjusting apparatus 30.

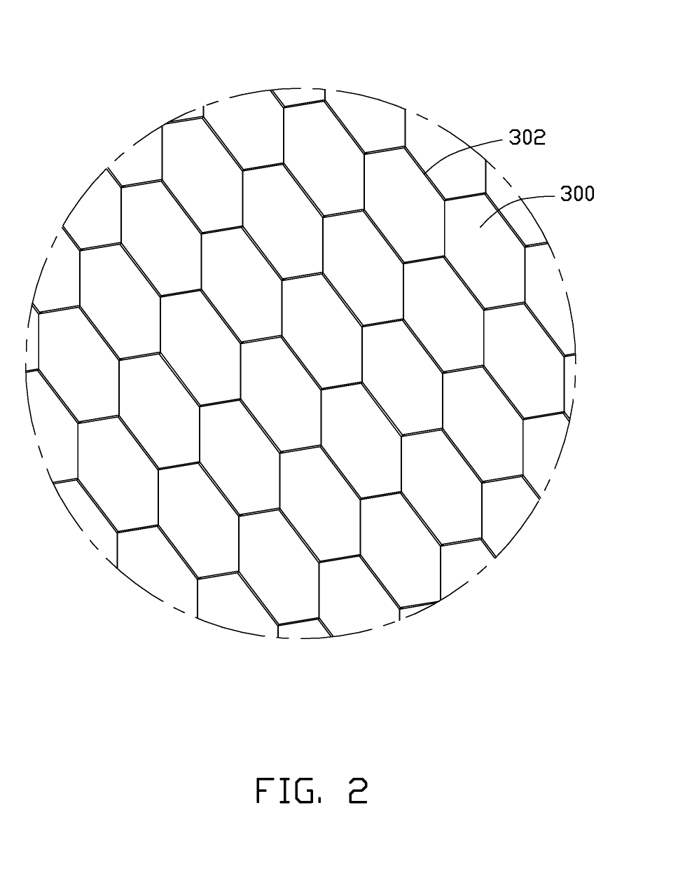

FIG. 2 shows that each ferrite plate 300 is hexagonal, and are arranged in a honeycomb layout. An edge length of each ferrite plate 300 is less than a quarter of wavelength of electromagnetic wave, which is required to be absorbed by the ITEs 500. Two adjacent edges of every two adjacent ferrite plates 300 cooperatively bound a slot 302. A length of each slot 302 is less than a quarter of wavelength of electromagnetic wave of the ITEs 500. In the embodiment, the edge length of each ferrite plate 300 is less than 0.075 meters (m), and each slot 302 is less than 0.075 m. Because the ferrite plates 300 are arranged in a honeycomb layout, every two adjacent slots 302 cannot align.

In use, one of the ITEs 500 is installed on the adjusting apparatus 30, the antenna 52 aligning with the ITE 500 can be used in electromagnetic measurement. The length of the slots 302 is less than the quarter of wavelength of the electromagnetic wave generated by the ITE 500 of the ITE 500, so the electromagnetic wave cannot enter the slots 302 and is mostly absorbed by the ferrite plates 300, to reduce useless reflectivity of the electromagnetic wave.

In another embodiment, the hexagonal ferrite plates 300 are tightly mounted on a top surface of the bottom wall 12 in a honeycomb layout.

Even though numerous characteristics and advantages of the embodiments have been set forth in the foregoing description, together with details of the structure and function of the embodiments, the present disclosure is illustrative only, and changes may be made in detail, especially in the matters of shape, size, and arrangement of parts within the principles of the embodiments to the full extent indicated by the broad general meaning of the terms in which the appended claims are expressed.

What is claimed is:

1. An electromagnetic anechoic chamber, comprising:
an anechoic chamber comprising a sidewall and a top wall; and
a plurality of hexagonal ferrite plates mounted on an inner surface of at least one of the sidewall or the top wall;
wherein the ferrite plates are tightly arranged in a honeycomb layout, an edge length of each ferrite plate is less than a quarter of wavelength of electromagnetic wave which is required to be absorbed by the ferrite plates.

2. The electromagnetic anechoic chamber of claim 1, wherein the edge length of each ferrite plate is less than 0.075 meters.

3. The electromagnetic anechoic chamber of claim 1, wherein two adjacent edges of every two adjacent ferrite plates cooperatively bound a slot, a length of each slot is less than a quarter of the wavelength of the electromagnetic wave which is required to be absorbed.

4. The electromagnetic anechoic chamber of claim 3, wherein a length of each slot is less than 0.075 meters.
